(19) United States
(12) Patent Application Publication
(10) Pub. No.: US 2024/0213561 A1
(43) Pub. Date: Jun. 27, 2024

(54) METHOD FOR SEPARATING CATHODE METAL OXIDES

(71) Applicant: Zaid AL RAYYES, Bedford (CA)

(72) Inventor: Zaid AL RAYYES, Bedford (CA)

(21) Appl. No.: 18/539,723

(22) Filed: Dec. 14, 2023

Related U.S. Application Data
(60) Provisional application No. 63/434,392, filed on Dec. 21, 2022.

(51) Int. Cl. H01M 10/54; C01D 15/02; C01G 45/02; C01G 51/12; C01G 53/12; H01M 4/48; H01M 4/58; H01M 10/0525

(52) U.S. Cl. CPC H01M 10/54; C01D 15/02; C01G 45/02; C01G 51/12; C01G 53/12; H01M 4/483; H01M 4/58; H01M 10/0525; H01M 2004/028

(57) ABSTRACT

Disclosed herein is a method and chemical process for separating the cathode metal oxides of lithium-ion batteries. The main utility of this method is in recycling the cathode active material of used batteries to effectively offer a closed route supply chain solution for battery manufacturers. The invention acts on transition metal solubility in a unique way by using excess ammonia to separate transition metal compounds from lithium as hexammines through a ligand substitution reaction. It is tailored for recycling NMC cathodes and can adjust to process various chemistries depending on future demand.

### FIELD OF THE INVENTION:

The present invention relates generally to a battery recycling process and more specifically to a method for separating the metal oxides in NMC cathode active material.

### BACKGROUND OF THE INVENTION:

From an overall market perspective, lithium nickel manganese cobalt oxide (NMC) as cathode active material in lithium-ion batteries is the most popular class of oxides being produced globally. Considering that the drive towards electrification of vehicles will increase battery production demands, sourcing the precious metals required to meet this demand will become more challenging as mineral deposits are depleted. Using secondary sources like spent batteries to recycle their active material instead of mining more resources is essential to closing any future supply chain gaps in cathode production.

An NMC specific recycling/separation process has been developed and while it can adapt with different chemistries the focus is on processing nickel rich NMC compositions. Disassembling a battery cell is the first step to obtaining the cathode feed for this process. A common feature of processes found in prior art is the use of shredding as a disassembly technique to quickly expose the cell components. The issue with shredding is that the resulting mixture would need to undergo further physical separation to get the desired feed assuming that subsequent chemical processing utilizes material specific circuits. This separation is challenging from technical and material handling perspectives—bypassing it would require a very complicated chemical process to separate active material from a mixture of anode and cathode material, which is used by some process in industry. The novel process can separate various cathode compositions in a simple, efficient manner without shredding batteries—disassembly was done manually to isolate the cathode.

Prior art utilizes precipitation or solvent extraction, and sometimes electrochemical extraction, as the principal concept to separate and recover transition metals and lithium from cathode material. Direct recycling is also an attractive area of research and development, avoiding the need to chemical separate cathode metals—the prior art for this class of process focuses on ways to relithiate the cathode material while maintaining its original structure and morphology instead of destroying and reforming the oxide structure as is preferred here. Moreover, previous methods involve additional steps related to disassembling battery cells and separating the internal components prior to processing. The method disclosed herein utilizes a different concept for chemical separation and also focuses on providing a process employable for all types of cathode active compositions, without depending on a particular disassembly technique. In prior art, precipitation occurs by titrating the leach liquor with a base like sodium hydroxide such that as the pH of the leach liquor increases the metal hydroxides precipitate out of solution in order of increasing electromotive potential. The problem with this as a separation technique is co-precipitation—the transition metals used in cathodes precipitate at similar pH ranges, so recovering high purity transition metals through this route involves complicated reaction control techniques. Solvent extraction, typically involving mixer-settlers at a commercial scale, works by separating the metals based on solubility differences in immiscible organic-aqueous systems. The method presented here utilizes precipitation in a unique way as a single step recovery and separation technique (instead of successive) before acting on the water solubility of lithium hydroxide as an extraction property.

### BRIEF SUMMARY OF THE INVENTION:

To briefly describe the unique operating method, NMC material is leached in sulphuric or citric acid before precipitating it with excess ammonia. During precipitation, the aqueous cobalt and nickel ions are reduced to hydroxides before undergoing a ligand substitution to form the ammine complexes. These complexes reside in solution, and the precipitate of lithium and manganese hydroxide is easily recovered by subsequent solid-liquid separation. Washing the precipitate in a dilute base or water then dissolves the lithium hydroxide. The separated metals are then oxidized by reacting with a reducing agent like hydrogen peroxide or by heating in a furnace. Separated metal compounds are then refined for reuse as cathode active material, offering a versatile closed-loop recycling method.

### BRIEF DESCRIPTION OF THE DRAWING:

FIG. 1 shows a flowchart of method steps, as well as materials used by the main embodiment of a process provided herein.

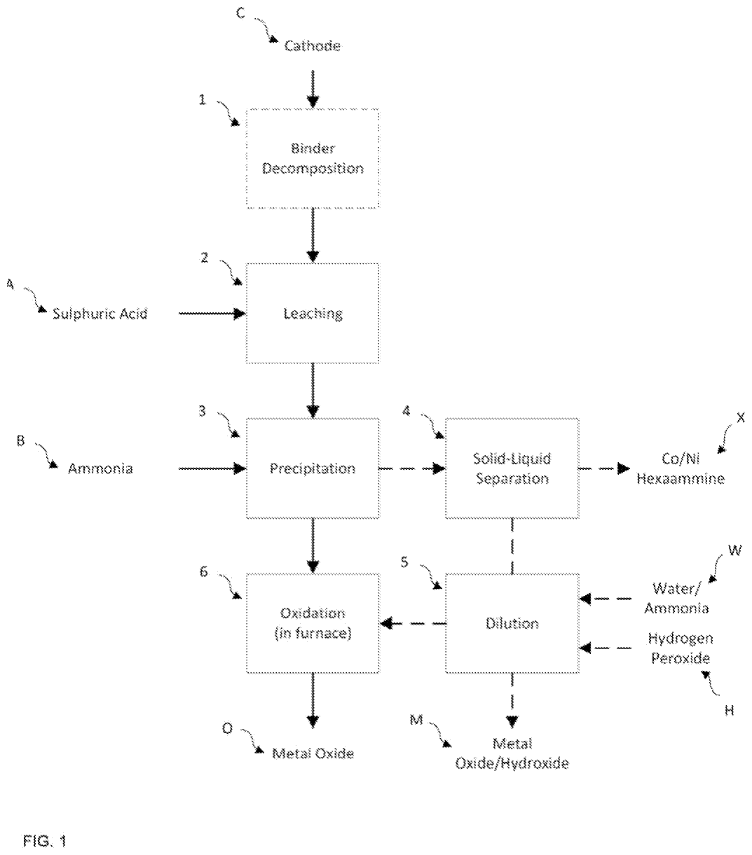

### DETAILED DESCRIPTION OF THE INVENTION:

The present invention utilizes NMC cathode active material as the process feed. Since there is no standard way to disassemble a battery cell and collect electrode active material, some embodiment may comprise a binder dissolution step to decompose the binder that attaches active material to the current collector. Anodes appear to have transitioned to water-soluble binders like CMC—anode active material can be easily removed from the current collector by dissolving the binder in water. Cathode binders are not water soluble—a popular area of battery R&D is in the development of water-soluble cathode binders, which would simplify and combine this step for anodes and cathodes. From a technical and commercial perspective, however, it appears that plastic binders like polyvinylidene difluoride (PVDF) will continue to be used for industrial battery production, so it is important for this method to be able to handle/pre-process cathodes comprising oxides with plastic binders. For these embodiments, a binder decomposition step (1) is required to release the active material from the current collector (typically an aluminum foil). Wet or dry routes may be used in this step—the cathode is immersed N-Methylpyrrolidone (NMP) solvent to selectively dissolve the binder in wet routes, whereas in dry routes the cathode is placed in a furnace and heated to at least the binder decomposition temperature. The main embodiment requires only the active material as a starting feed and as such may function regardless of the binder decomposition method.

The main embodiment comprises the lithium nickel manganese cobalt oxide (NMC) of a lithium-ion battery cathode (C) as the feed source, an acid such as sulphuric acid (A) or hydrochloric acid as the leaching agent, ammonia as the base (B) or precipitating agent, hydrogen peroxide (H) as the oxidizing agent, and a furnace to heat the resulting compounds, and comprises the method steps of reacting/leaching (2) the cathode/oxide with the acid to form a lithium nickel manganese cobalt salt solution (sulphate or chloride salt, depending on the choice of acid) where each transition metal is complexed or coordinated with at least one water/aqua ligand, reacting (3) the resulting leach liquor/salt (sulphate or chloride) with excess ammonia to form a solution of nickel and cobalt hexaammine and precipitating lithium hydroxide and manganese oxide/hydroxide, separating (4) the precipitate from the liquid ammine solution phase by filtration, mixing (5) either phase with dilute base or water (W) and reacting either the solid or liquid phase, or both, with the hydrogen peroxide (H) to oxidize transition metals. Oxidation with hydrogen peroxide is optional, along with subsequent solid-liquid separation to recover a metal oxide/hydroxide (M). Instead of or alongside this oxidation, heating (6) the resulting metal compound, for example the manganese oxide or hydroxide in the furnace to at least its oxidation temperature is also effective in synthesizing the trivalent transition metal oxides (O), for re-use as cathode active material. Cobalt and nickel hexaammine (X) compounds (chlorides or sulphates in the case of hydrochloric or sulphuric acid leach, respectively) are also produced by this method. Heating the nickel/cobalt sulphate or chloride ammine solution in the furnace to any temperature that evaporates the solution to precipitate the ammine as a crystal is the final step in the process for this material to be used in subsequent processing or directly in the production of cathode active material. Instead of or alongside this heating step, or even after the separation step (4), one embodiment proceeds further to separate the nickel from the cobalt ammine by reacting the ammine solution or crystal with acid (such as sulphuric or hydrochloric acid), crystallizing the cobalt ammine while the nickel complex remains in solution—effectively utilizing a new form of anti-solvent precipitation to solve the unique challenge of separating these two similar transition metals. Subsequent filtration and heating of either the cobalt compound or nickel solution or both in a similar manner to the previous embodiment yields the individual metal products and achieves complete separation of the original cathode metal oxides. The inertness of the cobalt hexammine versus the reactivity of the nickel hexammine in acidic environments is the second separation concept and inventive step disclosed. Determining the quantity of excess ammonia, along with other quantities including sulphuric acid, hydrogen peroxide and water, depends on the quantity of cathode material required for processing.

This separation method was designed specifically for NMC batteries considering their expected continued success as EV battery cathodes. It does not limit the invention from processing other cathode chemistries like LCO but the realization behind this as a novel recycling and separation method came from testing alternative ways to separate the four NMC metals. Manganese sulphate reduces to its hydroxide complex upon reaction with ammonia, precipitating as a hydroxide. Lithium, nickel and cobalt also react in a similar manner, however in the presence of excess ammonia, only the nickel and cobalt hydroxides undergo a ligand substitution wherein the water/hydroxide ligands are replaced with ammonia ligands—the octahedral metal complex is maintained in forming these hexammines, and the metal oxidation state changes from two to three. Instead of ligand substitution, manganese is oxidized in this environment to form its oxide which is anyways insoluble in solution. In effect, since the lithium and manganese compounds formed are insoluble in excess ammonia, the precipitates can be collected by filtration. Thus far, a cobalt/nickel complex solution and a lithium/manganese precipitate have been separated and each product may proceed to various other chemical processes for reuse in batteries or in other applications. The next step in this process would be mixing with dilute base or water to dissolve the precipitated lithium hydroxide, then filtering the solution to collect solid manganese oxide and aqueous lithium hydroxide which can be dried and mixed with transition metal compounds formed in this process. As such the solubility of lithium hydroxide in water and the insolubility of transition metal hydroxides were utilized as the third separation concept.

The excess is defined as the additional amount of ammonia, in addition to—or in excess of—the stoichiometric quantity for precipitating nickel or cobalt hydroxide relative to the amount of nickel or cobalt comprising the oxide required to cause a ligand substitution reaction (for at least one of the transition metal complexes) of the water/hydroxide ligands of nickel or cobalt with ammonia ligands, forming a solution of nickel or cobalt ammine and precipitating lithium hydroxide and manganese oxide/hydroxide, thereby separating the nickel or cobalt from the lithium as an ammine phase.

It is to be understood that ammonia, or an excess thereof, refers to both solution and gas. By no means is this invention limited in its inventive step as a reaction in excess liquid ammonia. Liquid-gas or even solid-gas reactions are covered under the inventive concept, where in the latter case an additional step of precipitating the leached cathode material as metal salts (sulphates or chlorides, for example, when leaching in sulphuric or hydrochloric acid) or as oxides/hydroxides by reacting in excessive or stoichiometric quantities of ammonia (or titrating another base like sodium hydroxide, in excess or otherwise) before exposure to excess ammonia gas in a furnace at elevated temperatures also performs the ligand substitution reaction (of oxide/hydroxide/water ligands for ammonia ligands) to make and separate transition metal ammines. Another embodiment for the solid-gas phase method bypasses the leaching and precipitation steps to react the lithium transition metal oxide directly with excess ammonia gas to form the ammine phase. In these reactions, spinodal decomposition of the homogeneous starting oxide/sulphate/hydroxide yields two or more distinct nickel/manganese/cobalt phases and in effect offers a solid-state separation method. Subsequent dissolution in excess ammonium hydroxide isolates the separated transition metal phase from the bulk material by operating on the same principle of nickel/cobalt ammine solubility in excess ammonia versus alkali metal hydroxide insolubility disclosed previously.

Utilizing a high pH precipitation with the leach liquor being added to excess ammonia is unusual in current practice since doing so would be counter-intuitive to processes relying on precise pH control going low to high pH (titrating base to leach liquor) to separate metals based on precipitation pH, which represents a major group of processes used industrially. With the choice of excess ammonia as the base, precipitation can be used as a single-step recovery and separation technique—it is a key design feature that performs the desired separation (cobalt and nickel from lithium and manganese) in the simplest manner with the fewest controls. Appropriate quantities of starting materials/chemicals along with the apparatus and method steps disclosed here are the only things needed to achieve the recycling goal, thereby offering a feasible and scalable method for separating, producing or resynthesizing cathode compounds as metal oxides or nickel/cobalt ammines for use as or in the production of cathode active material in next generation metal-ion batteries.

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Claims:

1. A method for separating the cathode metal oxides of a lithium-ion battery, wherein the cathode comprises a lithium nickel manganese cobalt oxide, a binder, and a current collector, and comprising the steps of:
a) heating the cathode to at least the decomposition temperature of its binder, or reacting the cathode with a binder selective solvent,
b) reacting the cathode with an acid such as sulphuric acid to form a metal sulphate solution,
c) reacting the solution with excess ammonia to form nickel/cobalt hexaammine, lithium hydroxide and manganese oxide/hydroxide,
d) separating the solids from solution by filtration,
e) mixing a separated phase with dilute ammonia or water to dissolve the lithium hydroxide,
f) reacting any resulting compound, such as manganese oxide/hydroxide, with hydrogen peroxide or heating the compound in a furnace to at least its oxidation temperature, thereby producing transition metal hexaammines and metal oxides.

2. A chemical process for separating the cathode metals of a lithium-ion battery, comprising a lithium nickel manganese cobalt oxide, an acid such as sulphuric acid, ammonia, hydrogen peroxide and a furnace, and comprising the steps of:
a) reacting the oxide with the acid,
b) reacting the resulting solution with excess ammonia to form nickel/cobalt hexaammine, lithium hydroxide and manganese oxide/hydroxide,
c) heating the resulting mixture in the furnace to at least its oxidation temperature, thereby producing transition metal hexaammines and metal oxides.

3. A metal oxide produced by the method of any of the previous claims.

4. The use of a metal oxide produced by any of the previous claims as cathode active material in a lithium-ion battery.

5. A method for separating the cathode metal oxides of a lithium-ion battery, comprising a lithium nickel manganese cobalt oxide cathode, sulphuric acid, ammonia and a furnace and comprising the steps of reacting the oxide with the acid to form a lithium nickel manganese cobalt sulphate solution, reacting the sulphate with excess ammonia wherein the excess is an amount of ammonia in addition to—or in excess of—the stoichiometric quantity for precipitating nickel or cobalt hydroxide relative to the amount of nickel or cobalt comprising the oxide required to cause a ligand substitution reaction of the water/hydroxide ligands of nickel or cobalt with ammonia ligands, forming a solution of nickel or cobalt ammine and precipitating lithium hydroxide and manganese oxide/hydroxide, separating the precipitate from the ammine solution by filtration, and heating the nickel/cobalt sulphate ammine solution in the furnace to any temperature that evaporates the solution to precipitate the ammine as a crystal, thereby separating the nickel or cobalt from the lithium as an ammine phase.

6. A method for separating the cathode metal oxides of a lithium-ion battery, comprising a lithium nickel manganese cobalt oxide cathode, sulphuric acid and ammonia and comprising the steps of reacting the oxide with the acid to form a lithium nickel manganese cobalt sulphate solution, and reacting the sulphate with excess ammonia wherein the excess is an amount of ammonia in addition to—or in excess of—the stoichiometric quantity for precipitating nickel or cobalt hydroxide relative to the amount of nickel or cobalt comprising the oxide required to cause a ligand substitution reaction of the water/hydroxide ligands of nickel or cobalt with ammonia ligands, forming a solution of nickel or cobalt ammine and precipitating lithium hydroxide and manganese oxide/hydroxide, thereby separating the nickel or cobalt from the lithium as an ammine phase.

7. A method for separating the cathode metal oxides of a lithium-ion battery, comprising a lithium transition metal oxide cathode, ammonia and an acid such as sulphuric acid and comprising the steps of reacting the oxide with the acid to form a lithium transition metal salt solution, then reacting the salt with excess ammonia wherein the excess is an amount of ammonia in addition to—or in excess of—the stoichiometric quantity for precipitating the transition metal relative to the amount of transition metal comprising the oxide required to cause a ligand substitution reaction of the water/hydroxide ligands of the transition metal with ammonia ligands, forming a transition metal ammine solution and precipitating lithium hydroxide, thereby separating the transition metal from the lithium as an ammine phase.

8. A method for separating cathode metal oxides, comprising a lithium transition metal oxide cathode, ammonia, and an acid such as sulphuric acid and comprising the steps of reacting the oxide with the acid and with excess ammonia wherein the excess is an amount of ammonia that causes a transition metal ligand substitution reaction forming a transition metal ammine, thereby separating the transition metal from the lithium as an ammine phase.

9. A transition metal ammine produced by the method of claim 5, 6, 7 or 8.

10. The use of nickel or cobalt ammine made by the method of claim 5, 6, 7 or 8 in the production of cathode active material for a metal-ion battery.
